(19) United States
(12) Patent Application Publication
(10) Pub. No.: US 2010/0108874 A1
(43) Pub. Date: May 6, 2010

(54) FILM ELEMENT FOR DETECTING AUTHENTICITY

(76) Inventor: Loessil Fariborz Martin Zahedi, Munchen (DE)

Correspondence Address: HARNESS, DICKEY & PIERCE, P.L.C., P.O. BOX 8910, RESTON, VA, 20195, US

(21) Appl. No.: 12/451,415

(22) PCT Filed: May 21, 2008
(86) PCT No.: PCT/DE2008/000861

§ 371 Date: Jan. 7, 2010

(30) Foreign Application Priority Data
May 23, 2007 (DE) 10 2007 024 298.2

(51) Int. Cl. G06K 7/10; B29C 35/08; G06K 9/74; G01T 1/20

(52) U.S. Cl. 250/271; 264/400; 356/71; 250/364

(57) ABSTRACT

One embodiment of the present invention discloses a film element for detecting authenticity, particularly for security elements, security papers, documents of value, coins, chips, and the like, wherein it includes a transparent film and/or a motif layer or a structured layer, including or representing a luminescent motif. The transparent film is preferably made of polycarbonate or PMMA, and the luminescent motif is preferably introduced into the film element via laser processing, particularly laser engraving, via steel embossing or gravure printing or a kiss-cut method or via perforation.

The present invention relates to a film element according to the preamble of claim 1. The invention additionally relates to a security paper, a security document, a document of value, a coin, a chip, an item of daily use, a design element and a data carrier provided with a film element according to the invention as well as a method for producing a film element for detecting authenticity and a method for producing a security paper, a security document and a document of value such as a banknote.

It should be observed that counterfeits of objects of value such as security papers, security documents, documents of value such as, for example, banknotes, and items of daily use, but also of design elements are encountered in increasingly large numbers. At the same time, such counterfeits are increasingly difficult to distinguish from the originals, especially visually.

It is therefore the object of the present invention to further develop a film element according to the preamble of claim 1 such that this has an increased security against counterfeit compared with the prior art and a visually testable effect.

The object is achieved according to the invention with a film element according to the four alternatives, according to claims 1, 27, 41 and 42, a security paper according to claim 45, a security document according to claim 47, a document of value according to claim 48, a coin according to claim 49, a chip according to claim 50, an item of daily use according to claim 51 and a design element according to claim 52, a data carrier according to claim 53 as well as a method for producing a film element for detecting authenticity according to claims 54, 55 and 56 and a method for producing a security paper, a security document and a document of value such as in particular a banknote according to claim 57. Advantageous further developments of the invention are the subject matters of the dependent claims.

A first alternative of the film element according to the invention for detecting authenticity, in particular for security elements, security papers, documents of value, coins, chips and the like, is characterised according to claim 1 in that it comprises a light-collecting and light-conducting transparent film coloured with a daylight-fluorescent dye, in which a motif which luminesces in the visible spectrum in ambient light is introduced by specifically perturbing the intrinsic total reflection of the film.

It should be noted that in the following explanations relating to the aforesaid first alternative of the film element according to the invention, the term “transparent film” is used representatively or synonymously for a light-collecting and light-conducting transparent film coloured with a daylight-fluorescent dye, in which a motif is introduced by specifically perturbing the intrinsic total reflection of the film. The term “film element” or in the plural “film elements” is used consistently in the present document. In the simplest case, the “film element” consists of the afore-mentioned “transparent film”, in general however the “film element” consists of a plurality of different material layers as is explained hereinafter with reference to examples.

The invention thus proposes film elements having a luminescent security or authenticity feature which exhibit a visually testable effect and can also be tested by machine, wherein the manufacturing process (in part also the material) of the products according to the invention largely correspond to the state of the art. As an additional advantage, the classical (marketable) production plants undergo an economic appreciation due to the manufacture of the products according to the invention since these manufacturing methods constitute new refinement processes.

Film elements in the sense of the invention are particularly suitable for securing against counterfeits of documents of value or security documents such as banknotes made of paper or polymer films or other substrates, identity cards, passports, visa stickers, cheque forms, documents, stamps, airline tickets and similar such as labels, seals, packages or other elements for securing products. According to the invention, films provided with luminescent motifs can also be used in product design and in the packaging industry as decorative or informative elements such as book bindings, pens, CD sleeves, mobile telephone casings, toys, packaging containers, usage instructions etc.

The invention proposes the production of film elements having luminescent motifs. The base material used is a coloured light-collecting and light-conduction film based on preferably polycarbonate and/or PMMA. The film contains fluorescent dyes which convert the incident light into longer-wavelength light. Most of this light is reflected inside the film according to the reflection laws (total reflection) and only emerges again through the edges. The luminescent effect occurs both with light in the visible spectrum and also (in an intensified manner) under fluorescent light sources (UV lamps/black light). This luminescence decreases in relation to the film diameter but is retained even on very thin films and in the case of smaller film diameter, can then be detected more clearly under very bright artificial light or UV light or when viewed tilted at an oblique angle.

Light-collecting and light-conducting as well as luminescent film material such as, for example fluorescently coloured, light-collecting and light-conducting film based on polycarbonate or PMMA is used to produce the film elements according to the invention. The film elements can be designed according to the invention as a multilayer composite, which is applied to a substrate (e.g. security paper, polymer) as a self-supporting document or as a transfer film element in the form of a label (patch) or continuous film strip. The outline form of the film element can be freely selected in this case. Further embodiments can constitute security threads/strips embedded in valuable/security paper or emerging at the surface in windows or labels.

Graphical motifs are introduced into the film element with the aid of thermal or mechanical methods (or a combination of both). These include laser methods (corresponds to precise melting or foaming of the film material by means of a laser), embossing methods, in particular using the steel embossing preferred for valuable and security documents (appropriately designated here as gravure printing or intaglio), hot embossing methods, perforation as well as milling techniques.

In order to bring about a sufficiently striking or machine-readable fluorescence and/or ambient light luminescence/daylight luminescence as desired, a defined variation/deformation of the amorphous structure of the film body in the form of embossing, gravure, melting or punctiform foaming is required. The definably induced perturbations deflect light and are designed according to the invention as an arrangement of luminescent indicia.

The films according to the invention preferably have a thickness of 100 μm or less. Particularly when used for banknotes, a film thickness of about 40 μm is ideal. As a result of the small film thickness, usual embossings (hot or cold) into the bulk of the film material produce luminescence (ambient light luminescence/fluorescence) which is too weak for verification. Embossings are therefore to be introduced according to the invention in the form of stampings, i.e. depressions or elevations extending over the entire film thickness or introduced so that they project beyond the initial volume of the film. In this case, fine and at the same time deep profiles achieve particularly intensive luminescence. Embossed profiles in the form of dots and/or lines are to be preferred.

In a further embodiment according to the invention, motifs are preferably introduced into the film body by means of lasers in the form of line and/or dot grids. The intensity of the luminescence of the introduced grid elements which is to be induced is variably defined by the depth and width of the laser inscription. As a result of the relatively small film thickness, a perturbation induced by means of a laser at the surface would result in an inadequate intensity. The focusing of the laser should therefore preferably largely cover the volume of the film between the upper side and the lower side and create a light-deflecting, luminescent perturbation by means of defined material deformation (punctiform precise melting/foaming). Very fine structures can be read out as fluorescent under UV light or as luminescently visible in ambient light at an oblique angle; relatively coarser structures are luminescently visible in daylight or ambient light.

A further preferred embodiment according to the invention for security elements consists in a film element which is only semitransparently metallised in some regions (aluminium vapour deposition in vacuum) which is inscribed by laser in the metallised areas. Indicia from the exposed and penetrated film luminesce through the surface demetallised by the laser beam, caused by the perturbations introduced into the film body and supplied by the previously non-metallised light-collecting surface region.

Instead of the applied metallisation, this embodiment can likewise be provided with an opaque colour layer with the same luminescent result. The metallisation or colour layer can be applied according to the invention to a separate transparent (not necessarily likewise luminescent) film which is applied to the luminescent film material.

A variant according to the invention comprises a film element which comprises a metallised area surrounded by a non-metallised light-collecting area which was inscribed by laser before the metallisation applied thereover. In this case, the luminescent indicia can be read out through the semi-transparent metal layer with the aid of a strong ambient light or UV light source set in a punctiform manner in the light-collecting surface region which supply the luminescent motifs concealed below the metallisation via one of the two light-collecting surfaces of the film. UV light is preferred for backlighting the composite of film element and substrate. If security paper such as is used for banknotes is used as substrate, this preferably has a thinner fibre structure in the region below the film element which can be achieved with the aid of a watermark technique from the production technology point of view in order to ensure UV light to a sufficient extent for transillumination.

A combination of the two process variants is a completely semitransparently metal-vapour-deposited film which has been inscribed with luminescent indicia before the metallisation. Following application of the semitransparent metal vapour deposition over the entire surface, this is now also inscribed with a laser, wherein this laser removes the metallisation in a defined manner and introduces perturbations into the film body, disposed in the form of indicia which under UV light complement the concealed, previously introduced indicia to form an alphanumeric and/or pictorial motif.

For automated readout, coded information (e.g. barcodes) concealed on a “mirrored” label in the manner described previously for example can be read out by machine.

As a further security factor to protect against counterfeit, the semitransparently metallised areas can, according to the invention, also be provided with diffraction structures in the form of, for example, a hologram. Then, only a hologram is revealed to the uninformed observer.

The luminescent motifs can be arbitrarily formed as alphanumeric characters, as symbols, coded character arrangement (one- or two-dimensional barcodes) or images.

The motifs can be produced according to the invention by means of one or a combination of several methods.

The motifs produced according to the invention on the films are characterised by coloured luminescence. This luminescence is ensured both in daylight and general artificial light and also in UV light, wherein the proportional UV fraction of the light accordingly intensifies the inherent effect. The motifs can have any forms. Defined mechanical or thermal deformation of the film body produces variations in the luminosity of the motifs produced. Fine structures luminesce weakly whereas coarser structures have a higher luminosity, similarly to the way in which the print image in gravure printing can be varied by means of the width of the lines/dots. In this way, luminescent half-tones can also be produced which consist of dots and/or lines as in a copper or steel gravure.

The luminescent motifs according to the invention can constitute arbitrary patterns such as images, symbols, lettering and numbers and can be formed as complex graphics. In the sense of the invention, the non-authorised reproduction of the motifs is made considerably more difficult by the complex methods and by the carrier material which has restricted availability technically and in terms of colour.

There are no suitable copiers available on the market, which virtually eliminates the spontaneous creation of imprint counterfeits. The high exposure appearance of photocopiers would bring about a correspondingly stronger luminescence and/or would represent fine motifs which would only be visible at an oblique viewing angle (or under UV light), strikingly on the copy. Depending on the design, for example, fine spacings between individual lines or pixels would be overexposed, with the result that contours are not imaged in a copy. The latter effects is extremely suitable as copying protection.

A further embodiment of the invention is consequently a film element disposed on a banknote in which fine-structured motifs are embossed or laser-generated which are not visible when viewed under light in the visible spectrum (or daylight) but appear glaringly on a colour photocopy.

In addition, the market availability of the film material used can be suitably regulated with the aid of individualised specifications (colour, film diameter, film composite) on the part of the manufacturer and restricted to a defined clientele which further improves the protection from copying.

Whereas the plastics processing industry processes corresponding granules to form plates and rods, the production of films, here in particular thinner films which ensure sufficient light conduction/light coupling-out, is to a very great extent more complex and thus, the necessary methods are more difficult to misuse.

The copying of a luminescent film element as described here is consequently (due to the system) appreciably difficult. Even in the case of available film material, even the slightest deviations in the luminosity of individual pixels/motif elements would be striking. A recognizable pattern generated according to the invention such as, for example a human or animal portrait (as in the case of steel gravure portraits on banknotes) would immediately reveal recognizable deviations to the user in the case of a copy. This would also apply to a lesser extent to other patterns. Consequently, copying (imprint counterfeit/simulation) using scanners is made appreciably difficult; a detail and colour reproduction true to the original is barely achievable. Consequently, with the present state of the art both an imperceptible falsification and a counterfeit (1:1 copy or re-enactment) of the luminescent motifs generated according to the invention can be excluded. The continuous dynamic variation of the data caused by the incident light, according to the invention the intensity of the luminescent indicia, constitutes an appreciable protection from counterfeit (as in the case of holograms). A graphical re-enactment (imprint counterfeit/simulation) by means of scanners and digital printing could at best reproduce a rigid two-dimensional image which would be immediately striking due to the lack of dynamic variation of the luminescence by movement of the film element at which this is exposed to different angles of incidence of the light.

The features of the luminescent film element in the sense of the invention are equally suitable for creating self-supporting documents of value and security documents and also for securing documents based on substrates such as paper or polymer film.

Documents of value such as banknotes and also documents of monetary value such as credit cards, cheques, tokens, stamps, tax labels (cigarettes, alcohol etc.), lottery tickets, casino tokens, or vouchers can be provided with luminescent film elements according to the invention or can be created completely (in a self-supporting manner) on the basis of this technology as protection against counterfeit or forgery.

Security documents having high protection requirements can be provided according to the invention with the luminescent film element, in some cases fabricated entirely on the basis of such a film element. These include identity systems (identity cards, passports, driving licences) as well as security documents such as trademark protection seals, labels (e.g. for medicinal products), seals for security-sensitive equipment and containers (so-called tamper-proof seals) as well as warning labels and signs. Documents and official seals constitute another potential application.

There are three test levels for detecting authenticity:
1. The readability of the luminescent information is largely ensured under comparable light conditions as that of conventionally printed information. This meets the requirements for testing/verification of valuable and security documents which is easy to accomplish for the public without additional aids (possibly by tilting, at an angle of observation of about 45°). This meets the requirements of the so-called “first test level”.
2. Inscriptions with motifs, in the sense of this invention, from a specific degree of fineness (or introduced into a weakly coloured, accordingly weakly luminescent, film, e.g. blue) can in comparison only be identified with the assistance of a fluorescent light source or in very bright artificial light. This information variant makes it additionally difficult to forge or counterfeit the luminescent film element according to the invention. Depending on the colouring, it is possible to create film elements according to the invention which can only detect structures under UV light (fluorescent). Here, we talk of the “second test level”; i.e. using a relatively widely available aid for reading out.
3. The luminescent film element according to the invention can be applied in a defined manner to a substrate which is provided with (widely used according to the prior art) infrared-reflecting or infrared-absorbing pigments (e.g. printed). The information contained therein can only be read out with the aid of an IR sensor. Such a provision (printing) can also be made with magnetic pigments and the information contained therein can be read out with a corresponding magnetic field sensor. An arbitrary combination of the two methods is also possible and meets the requirement of security against forgery/counterfeit to a correspondingly increased extent. As a side effect, the provision/printing of the substrate or a carrier film with dark pigments enhances the contrast of the luminescence under daylight/artificial light conditions. Alternatively, the film element can be inscribed on the basis of an algorithm with cryptically encoded, luminescent indicia (e.g. two-dimensional barcode). With the necessary assistance of complex equipment not accessible to the general public for testing/reading out protected features, we talk of the “third test level”.

Motifs are created in a half-tone manner by producing a grid of pixels/lines in different line width and producing a light/dark effect (broader lines result in lighter dots/lines). In the sense of this invention, other than in conventional half-tone reproduction, the light parts of a motif are imaged as a pixel. Such a half-tone motif can be generated industrially as a grid or be designed as a gravure. As a novelty, however, inherent to the system, the gravure is designed by a line/dot representation of the light image portions which have a luminescent effect.

Fine-structured patterns can be “superposed” on coarser patterns on the same plane which is also possible in a complementary manner in combination with one another. Whereas the coarser patterns luminesce distinctly and rich in contrast, the finer patterns are only visible on tilting the surface (tilting effect at 45° viewing angle for example) or with the assistance of a UV lamp (test levels 1 and 2).

Diffraction structures generated with the aid of microprisms engraved/embossed in the light-collecting and light-conducting film coloured with daylight-fluorescent dye correspond to a monochrome luminescent hologram generated according to the invention. Due to the fineness of the structures, readout using UV light is to be preferred. Monochrome fluorescent holograms are generated according to the invention.

The illusion of moving, luminescent motifs can be achieved with grids comprising pixels having defined alternating line width which produce a cinematographic effect on tilting the film element according to the invention. Depending on the condition of the grid, the effect is visible in daylight and artificial light and UV light; by moving/tilting the document, the illusion of a movement/picture sequence is produced when viewed. Combinations of grid point designs can also bring the effect to bear as a UV light addition, in this case, a “rigid” motif which luminesces in daylight/artificial light would only exhibit au illusion of movement by gradual tilting under UV light.

As a further example, two (or more) films can be disposed one above the other, i.e. they form a film composite. Whereas indicia of the lower film (red) luminesce through the upper film (blue), additional indicia are applied in blue (combined to form a blue red pattern) and only made visible in combination in UV light (test levels 1 and 2). In terms of process technology, both coordinated films can be described simultaneously by means of a laser. The films are disposed one above the other true to register, e.g. separated from one another by a glass plate as a spacer having a defined thickness. The laser plotter, controlled via X/Y/Z axes, writes simultaneously on both films (alternately on the lower and upper), wherein mutually complementing structures make it possible to produce highly complex structures. The films are then laminated true to register. On this basis, the finest guilloche patterns acquire a new, very high efficiency following their virtual displacement from classical security and valuable printing as a result of modern reproduction techniques. The lines can alternatively according to the invention consist luminescently of the finest structured pixels which can be individually associated with an arbitrary graphical form (a b c 1 2 3 + * - _ · . = ° , etc.). As an additional security feature, these formed pixels can be frequency-modulated and disposed in varying sequence to lines.

Guilloches can also be arbitrarily created which complement each other under UV light. The coarser pattern forms a luminescent base in light in the visible spectrum (or daylight) whilst a finer pattern fluoresces under UV light and complements the coarser pattern. As mentioned above, this can take place on several planes and polychrome as well as monochrome on one plane.

Thus, preferably a plurality of light-collecting and light-conducting transparent films, disposed one above the other and/or adjacently to one another, and coloured with a daylight-fluorescent dye, are provided in the film element according to the invention, in which a motif which luminesces in the visible spectrum in ambient light is introduced by specifically perturbing the intrinsic total reflection of the transparent films in each case. At the same time, intermediate layers which are at least partially transparent in the visible spectrum can be disposed in the film element, in particular between two transparent films disposed one above the other. In the case of transparent films disposed horizontally adjacent to one another in the film element, these can be spaced apart from one another or disposed directly adjacent to one another in such a manner that a light-conducting connection exists between the adjacently disposed transparent films. The transparent films preferably have different colours, in particular blue, green and red. The transparent films are preferably disposed on a substrate which is reflecting or semitransparent in the visible spectrum. Particularly preferably, the film element includes at least one layer with diffraction structures, diffraction lenses, in particular microlenses.

According to the invention, identity photographs (and any text boxes) can be protected and their authenticity ensured by sealing them with a (for example, blue) film which has fine motifs (patterns, inscriptions, grids) which only appear in UV light or fine red motifs at an oblique angle or when the film element is tilted.

Film elements having fine grids or spirals introduced onto (red) film by means of lasers which are visible in normal ambient light can as a simple but effective seal also serve as protection from counterfeiting. Likewise, according to the invention red/blue luminescent film laminate can be combined and provided with arbitrary indicia/patterns.

In a further variant, for example, during personalisation of an identity document, structures can be introduced on the (blue) seal film by means of lasers, taking into account the light regions of a photograph of a person, which are accentuated in a rasterized (also frequency-modulated) manner and can reveal the photograph of the person schematically (in a luminescent or fluorescent manner). In addition to this pattern, algorithmically designed information can also be provided which ensures machine readout of cryptic information (as a 2D barcode common on the market) (e.g. name and signature of the person depicted). From the process technology point of view, the photograph is scanned and processed by means of suitable software and converted by computer into the desired grid pattern which is introduced by laser into the film element overlaying the image (test levels 1, 2 and 3).

Similarly to conventional laser engraving methods in which patterns (pictures/texts/numbers) are introduced into a carrier with the aid of darkened pixels (grey scales), mutually complementary structures or half-tone pictures can be created with a film element according to the invention comprising, for example, a film composite of luminescent blue film and/or luminescent red and green film.

In addition to the conventionally created identity photograph, a laser-generated luminescent image of the finger prints can be introduced into identity cards which. as a result of its precision, is designed to be automatable, i.e. machine-readable. As desired, this biometric image can be shown in original size or in reduced size. The reduced-size image can also be laminated as a so-called tamper-proof seal into the digitally printed identity photograph. Ideally, identity photographs can be introduced in a half-tone manner by means of laser engraving into a multilayer film composite which is composed, for example, of blue, red and green pixels and in which defined luminescent or fluorescent pixels can be introduced into different film layers by means of a variably focusable laser. A cryptic 2D barcode (arbitrarily in red or blue luminescence or fluorescence) can be associated with this image information.

Laser perforation (also as micro-perforation) can also be used to the same extent as laser engraving. For this purpose, the laser is preferably focused in a manner which ensures an “initial melting” of the circular perforation, resulting in an intensive out-coupling of light. An identity photograph to be protected can, for example, be inscribed by means of fine perforation. Using luminescent red film, the edges of the individual holes of the perforation are visible in ambient light (luminous points). When examined against the light, perforations which are arranged as alphanumeric characters preferably form a further data carrier.

Structures such as “one-dimensional” and cryptically designed 2D barcodes (two-dimensional barcodes) are particularly suitable in which the film elements according to the invention are to be introduced by means of a laser. As a result of the extremely fine resolution, less substrate surface is required (which is important, for example, when using the film elements for identity cards or labels) and at the same time, increased security aspects are taken into account. In view of the attainable precision (and stable luminescence), the two barcode variants can be designed to be visible both in normal ambient light and also only in UV light (fluorescent) and as a result of the reliable machine-readability, are suitable for automation. The automated readout can be carried out with visible and/or UV light according to the defined intensity of the luminescence.

The exposed surface of the film element according to the invention is preferably sealed with a thin transparent coating (scratch-protective polycarbonate sealing as already used industrially for CDs) which protects the surfaces from damage. Otherwise, depending on the system perturbations caused by scratches could subsequently lead to undesirable light coupling-out effects.

The luminescent film element according to the invention can also be (partially) metallised by vapour deposition before the scratch-proof sealing or provided with monochrome luminescent diffraction structures.

Documents of value such as, for example, banknotes can be provided with strip- or label-shaped (i.e. patch-shaped) film elements. Strips of this type, in the same way as label-shaped laminates (i.e. patches) can be applied true to register to security paper rolls/sheets before the print cycle. The subsequent application of luminescent film labels according to the invention is also possible, possibly as is presently the case, for example, with commonly used label-shaped holograms.

The film element to be applied can be placed according to the invention true to register on a previously applied primer. The primer contains dark pigments which enhance the contrast of the luminescence and at the same time, save a dark coating as underlay in the film element. Likewise, already-mentioned IR-readable and/or magnetically equipped, seemingly flat dark print motifs can be used in the graphical substrate design.

The luminescent film elements according to the invention can also overlappingly line windows pre-stamped in a known manner in a document of value (e.g. a banknote) and can be tested by inspection. In this case, a film element is used which comprises a film or a laminate of two films which are provided with or without luminescent laser inscription and with a scratch-layer seal on the exposed surfaces. One embodiment constitutes a film element comprising an uninscribed film element which is sealed on both sides, which is subjected to a steel embossing printing cycle together with the substrate, with the result that the film element undergoes an embossing. A further variant would provide a film element which has luminescent indicia which, on bending the document to be tested and looking through the verification window onto an area of the substrate comprising a printed element or a label-shaped film element having likewise luminescent indicia, complement those printed and/or likewise luminescent indicia.

In order to take into account an increased aspect of security from counterfeit, in a further variant the luminescent film composite according to the invention (on a carrier film) is disposed in alternating colours. In strip form, such a combination (e.g. designed as red/yellow/orange/blue), arbitrarily without/with introduced structures, is applied to a document (e.g. a banknote) before/after/between individual printing processes as desired and is continuously numbered by means of perforation. Luminescent indicia can also be provided during a numbering run with the aid of numbering machines whose number wheels have letterpress types with sharp edges. The types can introduce without inking luminescent relief embossings into a film element provided for this purpose. To this end, the substrate is provided with a corresponding film element in the region of the numbering.

Alternatively, the film element according to the invention can also be configured (according to known production processes) as a window security thread. In this case, luminescent indicia are arranged on a (e.g. 2-6 mm wide) band-shaped film strip which is introduced into the paper web during the paper production (continuously) to such an extent that the thread re-appears at the surface of the security paper in partial areas. A corresponding band-shaped film element according to the invention comprises laser-introduced indicia which definably luminesce and/or fluoresce in ambient light. Linear or rasterized motifs can be used depending on the width of the thread/strip. A combination of laser-generated luminescent indicia/motifs and known metallisation/demetallisation methods can be used here, complementing one another. A further variant comprises a strip which is not luminescently inscribed before introducing into the paper web (window thread) which as part of a security paper, undergoes a true-to-register luminescent embossing on passing through a steel embossing cycle. In this case, regions of the film element covered with paper are engraved according to the invention which regions luminesce through the demetallised regions covered with paper when illuminated with a strong light source of visible light and more intensively, under UV light on both sides of the security paper. Even for inexperienced users, detecting the authenticity of the security thread according to the invention is easier than the window threads currently on the market.

Particularly in banknote and valuable printing, the associated refinement of the gravure printing/steel embossing method constitutes an upgrading of this now largely traditional (classical) security technology. The low tactility of current gravure printing products (e.g. banknotes) which fails completely in circulation in a very short time deprives the method of its security technology advantage. For some time, imprint counterfeits of gravure printing products by means of scanners and simple digital printers have been the order of the day.

In contrast to this, gravure printed products having film applications according to the invention have a more stable and haptically more impressive tactility as a result of the more plastic film engraving according to the invention and additionally luminescent motifs. This upgrading of the method has a significant economic importance internationally. About 90 (mostly state-owned) note presses worldwide have the expensive machines required for this which, depending on the machine, satisfy a rapidly diminishing security potential. By applying the film technique presented here the value of these machines is preserved and even increases. This upgrading constitutes a significant economic factor. The consumer and the national budget benefit from increased security and savings as a result of higher physical resistance. This should be seen from the point of view that throughout the world about 90 billion banknotes are produced annually.

As a result of the luminosity of the structures introduced into the films as patterns, the consumer additionally benefits from a simpler and clearer readability of the information. The communication of classical graphical information (security against counterfeit/forgery, relevant statements relating to the document, e.g. value etc.) is taking place more deliberately and more extensively as a result of the increasingly awakened interest of the consumer.

Some product applications may be presented hereinafter:

The application of film labels (patches) according to the invention based on laser-generated films or (relief embossed) films which been produced previously by means of gravure printing is very economical since a considerable reduction in costs is achieved as a result of the gravure printing cycles saved during note production (patch application on the front or back to secure a banknote without gravure printing during note printing).

In one application variant, a non-inscribed (blank) film element is applied in label form (patch) to the substrate (front side of note) and is relief-embossed by means of a gravure printing cycle. This embossing results in the formation of tactile luminescent indicia. Fine embossings definably remain largely concealed on inspection whereas when the note is tilted, a brilliant image (indicia) can light up in a luminescent manner at a viewing angle of 45°. The latently luminescent image or the indicia can, for example, reproduce an associated main portrait in conventional gravure printing technology for verification. The latent tilting effect is caused by the luminescent effect of light coupling-out according to the invention having an intensified effect on the film side located opposite the embossing but occurring equally clearly at an oblique angle (e.g.) 45°.

A banknote according to the invention can additionally or instead be provided with a non-inscribed (blank) film patch on the back of the note. A single gravure printing cycle on the front side of the print sheet would in this case also engrave the patch on the back side in a relief-embossed region. Based on the principle described, the rear-side patch would have a brilliantly luminescent gravure which is detectable on inspection (90° or 45°), Depending on the choice of film thickness, film colour and embossing, this can appear to be luminescent or merely fluorescent.

Not least because of the production of a full-value, additionally luminescent gravure on the back of the note in addition to the multichrome-printed combined gravure design on the front, using a single gravure printing cycle, it is possible to talk of a technical economical upgrading of the gravure printing method which would appreciably benefit the relevant industry.

During the production of luminescent gravure printing according to the invention, either a hand gravure in softened steel or a drawing in the gravure manner is created in conventional technology by a classical copperplate engraver/engraver, preferably however a gravure is created using computer-generated rasterization which has now been established in the valuable and security printing industry. This drawing or the rasterization is preferably engraved by laser in plastic plates or directly into the gravure printing plates, as a further alternative by a CNC milling machine in a steel mother stock; a galvanoplastic further processing to steel embossing printing plates common on the market then takes place. In addition to the x-y axis, the laser beam or the milling machine follows a z-axis taking into account the depth. The z-axis determines the gravure depth of the steel embossing printing plates and (in the print run) the superiority and the tactility of the embossing profiles to be achieved in the security paper to be printed, which is provided with a film element according to the invention, which in turn affects the intensity of the luminescence of the embossed motifs. The deeper the gravure, the brighter the individual embossed image element luminesces subsequently. The depth determines the degree of deformation of the film element according to the invention. The specific break-up of the film surface, supported by sharp edges of the steeply held flanks of the gravure profile of the gravure printing plate results in a definable (meterable) luminosity of the luminescent pixels.

Alternatively, the gravures can be etched as usual in steel and a mother stock can be duplicated galvanoplastically in usual process technology and processed to form a gravure printing plate. Gravure flanks which can be achieved in this case however have a more obtuse angle which is less effective subsequently for the luminescence intensity.

Unlike the conventional gravure, however, the modulation does not follow the dark elements of a half-tone image (in line/dot form) but the modulation follows the light elements. The light image regions should appear as luminescent structures in gravure manner on the film elements according to the invention. The copperplate engraver therefore draws out the light portions with undiminished skill. A computer-generated rasterization is preferably created which represents the light regions of the motif as a dot/line arrangement to be engraved.

Whereas it is currently possible for anybody to inexpensively create imprint counterfeits of printed intaglio portraits using commercially available scanners and printers, no comparable copying technique exists for luminescent relief-embossed structures. The gravure printing technique in this way re-acquires its original surprising security importance.

In order to generate luminescent motifs using common industrial processes, a film element according to the invention is applied to a banknote in a predefined region, which element preferably has laser-generated luminescent motifs for complementing with the subsequent engraving. In the region of the film element, a relief embossing takes place during the gravure printing cycle. The substrate (security paper) in conjunction with the film element according to the invention is engraved under the very high pressure determined by the system. The sharp burrs of the gravure preferably designed with steep flanks severely deform the material and partly break the surface of the film along the predefined pattern. The resulting perturbation in the entire film diameter causes the embossing profile in the form of the plate gravure to luminesce as a result of the light coupling-out which is hereby intensified. The precise predefined matching of the gravure width and depth in the printing plate production produces filigreed and/or powerful and impressive luminescent structures as desired. In addition, a haptically plausible tactile plastic deformation of the film element takes place.

The preferable structure of the film element according to the invention for gravure printing applications consists of a self-adhesive carrier layer, one or more light-collecting films (e.g. red/blue/green) and a scratch-proof protective layer. A security paper substrate preferably has a watermark-generated lower fibre structure in the region of the application surface which is advantageous for the use of relatively thicker film elements and for the readout in transmitted light.

The complexity and the high degree of difficulty of the individual process steps as well as the restricted availability of the base materials and the production tools eliminates any copying of the technique. Changes to the overall visual impression in the luminescent gravure according to the invention would be disclosed even more strongly than in the printed gravure.

The subject matters according to the invention offer a far higher protection from counterfeit than, for example, common hologram applications which can now be simulated or even effectively copied as a result of the widespread use of products having diffraction structures in the packaging and advertising field.

Furthermore, continuous strips of film material (about 1-1.5 cm wide) applied to security paper rolls are feasible, which strips can be provided or not provided with motifs when intended or prefabricated for gravure printing relief embossing in note production. According to the invention, the film can either be laser-inscribed or/and used, after further processing, engraved by gravure printing.

There are at least three variants for viewing window labels:

Variant 1: a window stamped in the substrate (or recessed from the fibre structure during the paper production) is lined with a transparent label (overlapping), wherein the label can be luminescently pre-inscribed or luminescently relief-engraved using gravure printing. Both exhibit visual effects either when inspected or when viewed at an oblique angle.
Variant 2: a window stamped in the paper (or polymer) substrate is lined with the transparent film label according to the invention (overlapping), wherein the label has a luminescent motif which correspond to a printed motif, by complementing this for example. Suitable for this purpose is a motif printed in dark colours which has light pixels which complement the luminescent pixels to form a plausible easily recognizable pattern. Alternatively, the window lining contains, for example, blue motifs which are complemented with a red-luminescing label laminate on a red film applied opposite thereto (the latter motifs can be pre-inscribed by laser and/or configured to be embossed by gravure printing. In a banknote put into circulation, a verification motif can be viewed and read out on the opposite side through the window by bending/folding the note.
Variant 3: the film label lining the window can also be designed to be partially metallised or definably demetallised and/or it can have diffraction structures. The opposite corresponding laminate can have luminescent motifs which for checking (disposed one above the other) can reveal additionally disclosed luminous information through the demetallised regions. In this case, it should be borne in mind that the luminescence is based on deflection of the light collected on the film surface and a sufficient part of the film (edge) must be made accessible to the incident light.

Luminescent film elements according to the invention can also be used as part of a self-supporting polymer banknote. A feasible banknote concept of the future could appear as follows: an intelligently combined film composite approximately one and a half times the size of a cheque card, consisting of metallised and definedly demetallised regions having diffraction structures, offset-printed (linear letterpress) and provided with a plurality of variants of the luminescent and varying luminous motifs according to the invention, generated by the gravure technique during the embossing print cycle and/or partially previously by laser.

Whereas scratching of the film material according to the invention can be prevented by means of corresponding commonly used coatings (as on CDs), a light deflecting edge can be produced by folding. The film may not therefore be used on typical fold regions (possibly the middle of the note). Holograms are similarly damaged however, if the diffraction effect is impaired by folds which have formed.

As a further preferred embodiment, film elements based on elastic daylight-fluorescently coloured plastic are coated onto a smooth preferably transparent substrate and stamped (kiss-cut method) or engraved as desired by means of a relief or a gravure which have steeply descending flanks or sharp burrs. In this case, due to the sharply designed burrs the elastic transparent film itself undergoes a deformation in the form of fine cracks and cuts which preferably penetrate the film volume but not the substrate. The resulting pattern of cracks and cuts forms a defined luminescent motif similar to the arrangement of the motif. As a result of the elasticity of the plastic, the cut edges return to the initial position after being acted upon and leave behind a predominantly smooth closed surface. Preferred methods are stampings (kiss-cut method) using flat and/or rotatively designed blades and also gravure printing (steel printing) without inking.

A further variant of the film element according to the invention according to a first alternative consists in producing luminescent motifs, also for cheque-card shaped laminates by laser engraving. High-modulation half-tone motifs are brought about on the basis of defined interruptions of the total reflection within one or more transparent films, in the form of pixels whose calculated structure is designed depending on the material property and the wavelength. With the aid of the geometry of the motif structure calculated in relation to the wavelength, both the angle of emergence of the light deflection and its intensity can be determined. The calculable scope for design of individual pixels also allows effects corresponding to “grey scales” to be achieved. The control of the intensity of the light deflection of individual pixels is brought about by generating structures whose definable geometry can have action variants which can be designed in graduations, from “diffusing lenses” (diffusers) to “mirrors”.

In a further variant, a film structure is coated onto a carrier film (or a substrate) consisting of superposed daylight-fluorescent coloured transparent films in the colours (from bottom to top) red, green and blue, each separated by a transparent intermediate layer having a different refractive index. With the aid of an X/Y matrix as well as three Z axes defining the depth (Z1=blue film/Z2=green film/Z3=red film), a polychrome motif is applied digitally and subsurface engraved by laser into the volume of the respective transparent film. In this exemplary embodiment, daylight fluorescent luminescent pixels in the colours red, green and blue can be applied three-dimensionally, in a defined manner adjacent to one another when viewed whilst the added colours yellow, magenta, cyan and white are produced true to register, by means of identical X/Y axes but superposed Z axes. White is produced in this manner with identical X/Y positioning by three laser-subsurface-engraved structures in the Z3/Z2/Z1 axes positioned one above the other in the respective films red, green and blue. Yellow is produced in the same way but in the axes Z3/Z2. The modulation of an image can be determined by applying the pixels in the colours red, green, blue, yellow, magenta, cyan, and white, the definable dimensions of the pixels and their density with respect to one another as well as additionally by the calculated geometry of the individual points which controls its individual luminous intensity. By means of this controllability, a varying shading can be associated with an addition colour (possibly yellow) produced by means of superposed Z axes, according to the defined intensity of the luminosity of the daylight-fluorescent coloured films, in the primary colours red and green, of the laser-produced structures. In order to enhance the contrast behaviour of the individual luminous points, the film structure with the films can be arbitrarily coated onto a dark-printed/coloured substrate/carrier film. This substrate can have reflective properties for better exploitation of the light to be deflected, for example, a dark metal layer, preferably applied by means of chemical vapour deposition (CVD). The metal layer is preferably transparent and conditioned so that as a layer component of a multi-layer laminate it does not form an easily cleavable weak point. Whereas a very light luminous point on a light background has scarcely any effect, nevertheless its brightness originates from the reflection behaviour of the light background, a similar reflection relationship can be created with the aid of a dark metal reflector, alternatively also with dark iridescent surfaces. A semitransparent CVD application allows a verification on examination, another hurdle for a counterfeiter, since an imprint counterfeit of the effects according to the invention is otherwise eliminated using means available on the market, but a film element having luminescent motifs when viewed appears as a monochrome transparent film material when examined.

An increase in the contrast behaviour of the individual luminous points within the three-dimensional matrix (red+green+blue structure) can also be brought about by means of a laser-darkening film which is laminated as an intermediate layer. The laser-darkening film is assigned its own Z axis and is darkened in a defined manner by the laser controlled by means of the X/Y axis (also possible in a second cycle). Ideally, an individual black ring around this is assigned in this case to a coloured luminescent pixel to optimise the contrast. The visual effect of the luminous points is primarily determined by the respective contrast ratio with the surroundings, very light luminous points are barely visible against a white subsurface whereas relatively weakly luminous points stand out relatively clearly against a dark subsurface.

A film element comprising a transparent film preferably based on elastic daylight-fluorescent coloured plastics on and under which protective and/or intermediate films are laminated is laminated onto a smooth substrate and is engraved with this by means of a gravure having steeply descending flanks and sharp burrs or is stamped (kiss cut) with a sharp-edged profile or engraved as desired. Preferred methods are stamping (kiss cut) with flat and/or rotatively designed blades and also gravure printing (steel printing) without inking, for example as relief embossing. In this case, due to the sharply designed burrs the elastic transparent film material undergoes a deformation in the form of fine cracks and cuts which preferably penetrate the film volume but not the substrate. The resulting pattern of cracks and cuts forms a defined luminescent motif similar to the arrangement of the motif. As a result of the elasticity of the plastic, the cut flanks return to the initial position after being acted upon and leave behind a predominantly smooth closed surface. Plastic polymers, on the other hand, acquire a resistant luminescent profile which can be assigned a definable haptic.

In order to make use of the addition behaviour of primary colours, in a further embodiment of the film element, the stamping blade has up to three planes of different height on the Z axis. With the aid of such an apparatus, the stamping in the form of a kiss-cut would not only initiate daylight-fluorescent luminescence of a single discharging transparent film but up to two further transparent films which are preferably separated from the first on two respectively additional planes, interrupted in each case by a transparent colourless intermediate layer. In this embodiment (from bottom to top) the colour sequence is necessarily red/green/blue. By stamping the film element from behind, by means of, for example, defined pointed, conical or pyramid-shaped stamping pins in three height levels, perturbations can be produced in the volume of coloured film planes layered one above the other which can bring about arbitrarily ordered, luminescent pixels disposed on an X/Y axis, adjacent to one another and also above one another, and is thus suitable for generating a polychrome motif. The adjacently disposed luminescent points can each be assigned one of the three (primary) film colours used whereas luminescent points disposed above one another in the Z axis can be produced additively, in addition to red, green and blue, yellow and white luminescent pixels.

Since the transparent film in plastic design is sensitive to perturbations due to surface or volume deformations, possibly in the form of luminescent spots, it is not expedient to laminate this in the film element onto a substrate or for this to be used as a self-supporting security element/document without a protective layer disposed thereabove and a vapour-deposited layer disposed thereunder in the form of protective film matched to the material and/or adhesive having corresponding elastic properties. The protective or intermediate layers disposed thereon and/or thereunder absorb the daylight fluorescent light supplied by the transparent film with the same refractive index and deflect it at the material changes (particularly cracks and/or distortions) formed externally and/or in the interior of the film element with the aid of perturbations of the total reflection hereby produced inside the film composite in a defined manner in the form of luminescent motifs.

In a preferred embodiment, the layer structure of the film element is composed vertically from bottom to top of an adhesive layer, a contrast layer, a layer having diffraction structures, a transparent light-collecting and light-conducting film coloured with daylight-fluorescent dyes, and a transparent protective layer. When integrating the transparent film into the layer structure of the film element, this is largely protected from environmental influences towards the outside and cannot be removed in isolation in order to be introduced functionally into forged reproductions during attempts at tampering or forgery.

A further embodiment of the film element provides the plate-like introduction of transparent films into a film structure which is composed of preferably one film designed as a contrast layer on which a further film having incorporated diffraction structures is laminated, a platelet consisting of the transparent film material is disposed on this and over this, an extensive transparent colourless protective film. The structure is made true to register with the aid of usual techniques and measures which avoid slippage of the largely loose platelets. Now, the protective film is spot-welded from above, by means of ultrasound technology, for example with the film having diffraction structures which is located thereunder, using an embossing sheet provided for this purpose and equipped with corresponding elevated patterns. In this case, the weld spots in the areas surrounding the embedded transparent film platelet form a homogeneous material unit with the film located thereunder. In the edge region of the platelet, a weld seam is incorporated with an arbitrary associated daylight-fluorescent luminescent pattern, forming a material unit between the three structure layers. The area of the welded-in platelet is provided on the embossing sheet side with a fine, punctiform and bar-shaped elevated embossing motif and produces a corresponding characteristically luminescent pattern which can have the appearance of a steel gravure according to its design. Likewise, a luminescent motif can be introduced in a spot-welding manner using ultrasound [onto] a completed film element created on a laminate basis, by means of an embossing stamp used in register.

A simple advantageous application provides the application of the film element onto a substrate which is ideally completely flat at the application point. In the case of a security paper, as is usual for banknotes, it is advantageous to introduce a calendering of the substrate which largely corresponds to the shape of the outline of the film element, in which a preferably clear, colourless UV-curing primer-varnish layer is applied. The calendering minimizes the dimensional application of the film element on the substrate by compensating for some of the height of the film element. For receiving label-shaped film elements, security substrate paper in the outline form of the labels is provided preferably during manufacture, with areas of thinner fibre structure (generated similarly to a watermark) instead of the calendering in order to ensure height compensation for the film element to be applied and also specifically a reduced opacity of the paper, which ensures a more permanent backlighting for test purposes, including by machine. The primer varnish layer additionally smoothes the calendered surface or the thinner paper area and simultaneously serves as adhesive. The primer can be given a suitable colour as desired, which serves as a contrasting subsurface for the film element, for example, in the case of a strip-shaped continuous application to a roll of paper or polymer substrate. The primer can also be provided with dyes which fluoresce in UV light to provide a further verification feature (verification level 2) for reading out by means of simple aids or it can contain afterglowing phosphorescing pigments such as, for example, similar to the substances produced by BAYER, marketed under the trade name LUNA. Arbitrarily, one of the protective or intermediate layers can also be enriched with a corresponding phosphorescent pigment and afterglow in the dark. The luminescent primer fills the bed in the paper substrate created by the pressure of the calendering or with the aid of a thinner fibre structure and ideally overlaps its profile edges. On both sides in the selected strip form and all around in the label form. These overlapping primer regions can also be assigned a graphical form by printing technology. The method described has the advantage that the film element need not be integrated in the production process for paper or polymer substrate but does not allow tampering for the purpose of attempts at reproduction without damaging the document to be protected, such as a banknote for example.

A second alternative of the film element according to the invention for detecting authenticity, in particular for security elements, security papers, documents of value, coins, chips and the like, is characterised according to claim 27 in that said film element comprises at least one light-collecting and light-conducting transparent film coloured with daylight-fluorescent dye and at least one light-conducting motif layer which is connected to the transparent film in a light-conducting manner and which is transparent in the visible spectrum, wherein a motif which luminesces in the visible spectrum in ambient light is introduced into the motif layer by specifically perturbing the intrinsic total reflection of the layer.

It should be noted at this point that in the following explanations relating to the aforesaid second alternative of the film element according to the invention, the term “transparent film” is used representatively or synonymously for a light-collecting and light-conducting transparent film coloured with a daylight-fluorescent dye, without a motif being introduced by specifically perturbing the intrinsic total reflection of the film. Furthermore, in the following explanations relating to the aforesaid second alternative of the film element according to the invention the term “motif layer” is used representatively or synonymously for a light-collecting motif layer which is transparent in the visible spectrum and connected to the aforesaid “transparent film” in a light-conducting manner, wherein a motif is introduced into the motif layer by specifically perturbing the intrinsic total reflection of the motif layer.

In the second alternative of the film element according to the invention, the at least one transparent film in conjunction with the film element thus merely serves as a source of corresponding fluorescence light. This fluorescence light is visible for an observer at the perturbations introduced into the preferably colourless, transparent light-conducting motif layer. In a particularly advantageous manner, the transparent film and the motif layer have an identical refractive index, at least for the fluorescence light produced in the transparent film. Preferably in the film element, the motif layer on the transparent film or adjacent to the transparent film is disposed directly adjacent to said film in each case. Here also, the luminescent motif is introduced into the motif layer by means of laser processing, in particular laser engraving or for example, by means of steel embossing or gravure printing. The transparent film preferably has a definable colour so that the motif layer can be supplied with light of this colour. Furthermore, the motif layer can be supplied with fluorescence light from a plurality of transparent films connected to the motif layer in a light-conducting manner. The motif layer is preferably applied to a preferably dark substrate which is provided with, in particular printed with, infrared-reflecting and/or infrared-absorbing pigments. The motif layer preferably has fine-structured motifs which are not visible when viewed under light in the visible spectrum. The fine-structured motifs can be superposed with coarser-structured patterns on the same plane. The motif layer can also have diffraction structures generated with the aid of microprisms or it can be applied to an optical layer containing diffraction structures or microlenses etc. in order to achieve optical, for example, three-dimensionally acting effects when observed. Furthermore, the motif layer can be provided with a grid comprising pixels having a defined alternating line width which cause a cinematographic effect when tilting the film element. It is also feasible that a further such motif layer is laminated on the motif layer to form a layer composite, wherein the motifs contained in the individual motif layers complement each other. In one variant, the motif layer is provided with a guilloche pattern. In this case, the guilloche pattern can consist of at least two parts which complement each other under light in the visible spectrum and/or UV light to form a complete pattern. In another variant, the luminescent motif is configured as a motif which perforates the motif layer.

In an embodiment according to the second alternative of the film element according to the invention, two transparent films are disposed adjacently at a distance from one another in one plane, wherein a colourless, transparent light-conducting motif layer of the same refraction behaviour as in the transparent films is disposed in the intermediate space. Perturbations of the intrinsic total internal reflection behaviour of the layer are introduced into this motif layer by means of laser gravure. Depending on the incidence of light and the proximity to the transparent fluorescent transparent films, when viewed the perturbing structures introduced appear to be either colourless or take on the colour of the nearest transparent film. A freestanding laser subsurface-engraved writing between the transparent fluorescent films can appear colourless when viewed but when at an oblique viewing angle, this has the colour of the respective film. In addition, when illuminated with point illuminants (verification level 2, using simple aids) in an adjacent region of the transparent film, its colour can supply the writing. Longer-wavelength light (possibly red) is visually more readily perceptible for humans. If the writing at the boundary region projects from, for example, a green film, for example, into the green area and the other half lies in the colourless transparent area, the writing shows a pale green light when viewed, being somewhat strong when examined obliquely. If an illuminant is now shone into the green film region, the writing appears in radiant green. If a red film is located parallel to the writing and film at a short distance and this is illuminated, this red film supplies red light into the entire writing which also reddens the portions projecting into the green film region.

A third alternative of the film element according to the invention for detecting authenticity, in particular for security elements, security papers, documents of value, coins, chips and the like, according to claim 41 has features according to one or more of claims 1 to 26 and one or more of claims 27 to 40. Thus, this third alternative comprises features of the first and the second alternatives of the film element according to the invention.

A fourth alternative of the film element according to the invention for detecting authenticity, in particular for security elements, security papers, documents of value, coins, chips and the like, is characterised according to claim 42 in that said film element comprises at least one light-collecting and light-conducting transparent film coloured with daylight-fluorescent dye and at least one transparent light-conducting structured layer which is connected to the transparent film in a light-conducting manner, wherein the structured layer has a specifically predefinable structure corresponding to a motif and has material inhomogeneities which luminesce under ambient light in the visible spectrum. In a particularly preferred manner, the structured layer can be produced as a curable suspension by means of a printing method, for example, a suspension printer (inkjet).

In a particularly advantageous manner, a film element according to the invention according to Alternatives 1 to 4 is characterised in that the film element (10) has a thickness of <100 μm, preferably of <50 μm and particularly preferably of 5 to 30 μm.

In order to produce the previously described optical effects in the film element, in all four alternatives of the film element according to the invention, diffraction structures, microlens structures etc. can be introduced into the surface or as a layer inside a film element. Thus, the film elements can be sealed using self-adhesive or self-curing transparent materials with embedded particles having a different refractive index. In this case, the structure geometry of the information introduced into the film element and the particle size of the embedded particles must be matched to one another. Luminous pixels of a motif which has been internally marked in the film element by laser are combined with diffraction structures such as, for example, microlenses in planes located thereunder and/or thereover, preferably true to register, to produce a defined deflection of the light emergence angle of the individual pixel.

In order to produce the film element, in all alternatives 1 to 4, in particular for producing a composite of transparent films, optionally intermediate layers and optionally layers (according to Alternative 2), flowable, curable transparent plastics can be applied in planes one above the other by means of known printing methods. Thus, for example, a film element can be applied to a substrate by applying dissolved, transparently curable plastics to which a daylight fluorescent dye has been added, by means of inkjet/screen/flex/intaglio printing in a plurality of planes one above the other in different colours (red, green, blue as well as additionally colourless). By marking the respective cured film layers with colourless crystal dust suspension ink, having a different light refraction angle, for example, by using an inkjet luminous motifs are produced in the colour of the respectively wetted film. Commercially available means for this are, for example, Noriphan from Pröll, a liquid polycarbonate solution.

Furthermore, the film elements of all four alternatives can comprise transparent UV-curing varnish layers having the same refractive index as the daylight-fluorescent coloured film(s), which are supplied by the transparent film(s) and luminesce in the respective film colour in ambient light.

The vertical structure of the film element should be a maximum of 50μ, wherein the film element should preferably be dimensioned in a layer thickness of 10-30μ. The reconstruction of very thinly dimensioned film elements constitutes another hurdle for the counterfeiter. It is not possible to release the daylight-fluorescent film material from the layer structure without destroying the substrate and the security element since the adjoining film material forms a unit with this, brought about by partially dissolving the boundary surfaces and combining to give an optically homogeneous body or alternatively laminating in hot presses, with the same result. Cleaving a preferably 10-50μ thin, largely homogeneous film laminate in order to obtain reconstruction material for counterfeits requires a disproportionately large effort.

In order to ensure the greatest possible economic viability and additionally restrict the amount of film material supplying fluorescent light to a minimum, the daylight-fluorescent film constituents should be designed to be as thin as possible as has already been explained in detail elsewhere. Furthermore, they need not necessarily be introduced over the entire surface. Rather, the usual requirements of efficient industrial production should as far as possible not be met here and the thin film material in the form of labels or platelets corresponding in their dimensions to the area of an intended characteristically luminescent motif should be applied selectively to the extensive sheets of suitable structure layers. Lamination into a film structure which is executed by means of a hot printing press also for usually about 800μ thick polymer cards is well-suited for polycarbonate, for example, where the definedly placed, embedded, up to 60 p thick plates are integrated homogeneously between two transparent layers without any displacement problems. The intensity of the luminescence decreases with increasingly thick transparent layer structure on the transparent film, but can be controlled when producing the granules prior to extrusion by means of the mixing volume with the daylight-fluorescent dye.

In order to prevent copying of the information contained in the film elements, described in this document, for example by means of UV varnishes or similar methods, the material layers which are carriers of the introduced information, i.e. the transparent film (according to the first alternative) or the motif layer (according to a second alternative) or the structured layer (according to a fourth alternative) are located inside the film elements and are connected to one another in such a manner that separation of the individual material layers would result in destruction of the introduced information or the specifically produced luminous effects. Tampering of the information contained in the film element is thus eliminated. Imprint forgeries are also eliminated or at least made very difficult since the information contained in the film element is not based on the surface of the film element, for example, by information-dependent structures but is encoded inside the film element. Finally, the optical effects produced cannot be copied using conventional methods.

Further advantages, features and characteristics of the invention are obtained from the following description of preferred but not restrictive embodiments of the invention with reference to the schematic drawings which are not to scale. In the figures:

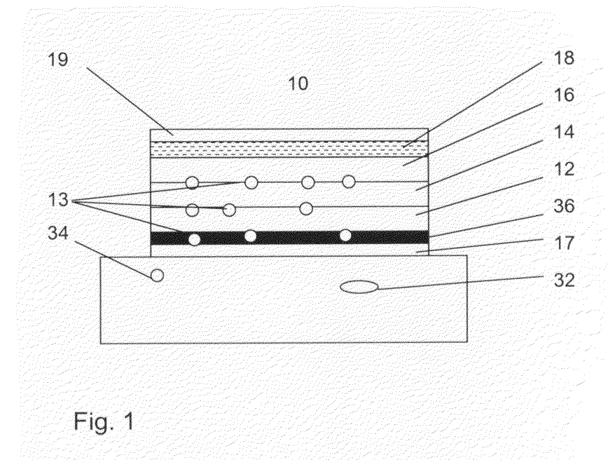

FIG. 1 shows a sectional view of an advantageous embodiment of the invention according to a first alternative in the form of a film composite disposed on a substrate and

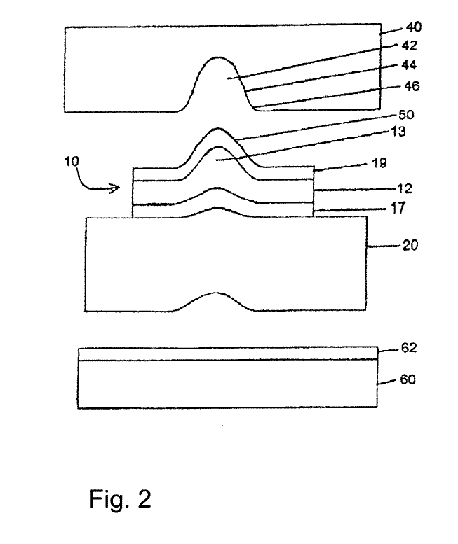

FIG. 2 shows a sectional view of a film element according to the invention following embossing by a gravure printing plate.

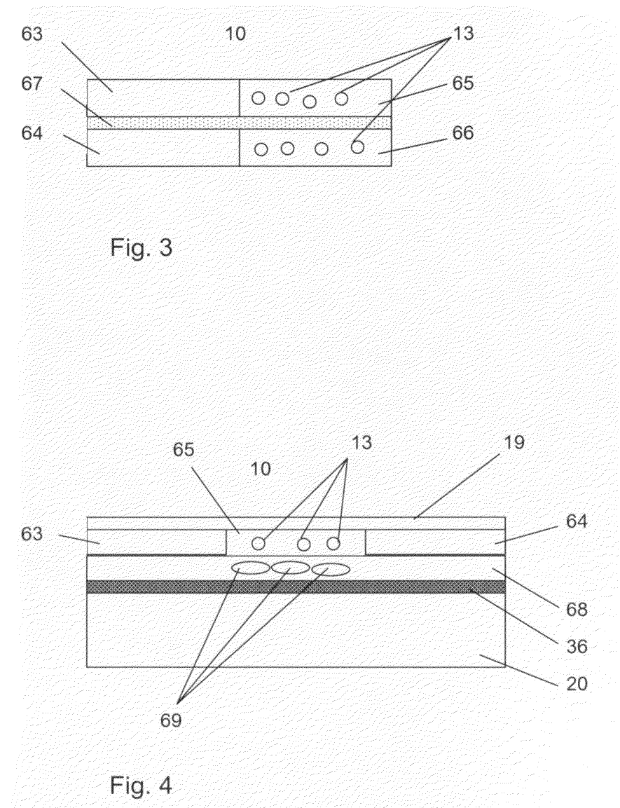

FIG. 3 shows a sectional view of an embodiment of the film element according to a second alternative

FIG. 4 shows a sectional view of a further embodiment of the film element according to a second alternative

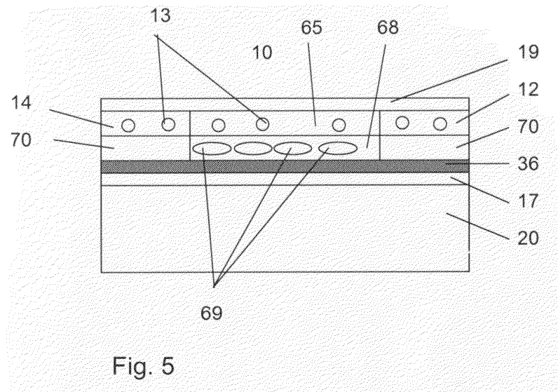

FIG. 5 shows a sectional view of an embodiment of the film element according to a third alternative.

FIG. 1 shows a structure of a film element 10 according to the invention according to a first alternative. The film element 10 comprises light-collecting and light-conducting transparent films 12, 14, 16 coloured with daylight-fluorescent dye, in which a motif 13 which luminesces in the visible spectrum in ambient light is introduced by specifically perturbing the intrinsic total reflection of the film. A contrast layer containing dark pigments 36 and three transparent films 12, 14, 16 each comprising luminescent information are applied by means of an adhesive layer 17 to a substrate 20 which is provided with, in particular is printed with, infrared-reflecting and/or absorbing pigments 32 (only shown schematically) as well as magnetic pigments 34. A metallisation layer 18 and a scratch-protective sealing layer 19 are applied to the films 12, 14, 16.

As indicated in FIG. 2, a film element 10 according to the invention is embossed by steel embossing (also known as gravure printing or intaglio) (executed without inking as relief embossing). In this case, the transparent film 12 located on the substrate 20 is pressed against a steel plate 40 fitted with lower-lying gravure elements 42 by means of a pressing cylinder 60 fitted with a rubber mat 62. As a result, an embossing 50 is formed with burrs 46 which brings about light-deflecting imperfections in the form of luminescent information 13 in the film volume which is configured in the form of gravure motifs. The desired intensity of the luminescence is definably achieved by means of the embossing depth and/or width of the gravure lines or dots. Steel embossing printing plates created using known methods such as laser gravure in polymer material which is galvanoplastically further processed are particularly suitable for achieving definable-depth and at the same time fine gravures having preferably steep side flanks 44.

FIG. 3 shows a sectional view of an embodiment of the film element 10 according to a second alternative. The film element 10 comprises two light-collecting and light-conducting transparent films 63, 64 coloured with daylight-fluorescent dye, and two light-conducting motifs 65, 66 which are connected to respectively one of the transparent films 63, 64 in a light-conducting manner, and which are transparent in the visible spectrum, wherein respectively one motif 13 which luminesces in the visible spectrum in ambient light is introduced into the motif layers 65, 66 by specifically perturbing the intrinsic total reflection of the motif layers 65, 66. The perturbations of the intrinsic total reflection of the layer are represented by circles 13. Naturally, in reality extremely fine perturbing structures can preferably be introduced into the motif layer by means of laser technology. Depending on the spatial resolution of the laser technology used, for example, a femtosecond laser, high-resolution image information can be introduced in the form of corresponding perturbing structures. In this respect, the transparent films 63, 64 serve as a source of fluorescence light, preferably of different colour and feed this into the motif layers 65, 66. For this purpose, the optical refractive index of the material of the transparent film 63 or 64 is preferably equal to that of the motif layer 65 or 66. In the present case, a transparent layer having a refractive index different from that of the motif layer or motif layers is provided as an intermediate layer 67.

FIG. 4 shows a sectional view of another embodiment of the film element 10 according to a second alternative. Located at the centre of the film element 10 is a motif layer 65 having an introduced motif 13. Fluorescent-light producing transparent films 63, 64 are disposed laterally directly adjacently, i.e. having a light-conducting connection. All these elements form a horizontal layer on which a scratch-protective layer 19 is applied. Located below this horizontal layer is a transparent layer having microlenses 69 and a dark contrast layer 36 on a substrate 20.

FIG. 5 shows a sectional view of another embodiment of the film element 10 according to a third alternative. Unlike FIG. 4, motifs 13 are now introduced into the light-collecting and light-conducting transparent films 12, 14, which are coloured with daylight-fluorescent dye and which horizontally adjoin the motif layer 65, by specifically perturbing the intrinsic total internal reflection of the films. In this version, mirror layers 70 are located below the transparent films 12, 14. Furthermore, the film or layer composite is applied to a substrate 20 by means of an adhesive layer 17.

Film elements embossed according to the invention are generally not self-supporting. They should preferably be engraved after application jointly with the substrate (by means of steel embossing/gravure printing as known in valuable or security printing).

It is understood that the invention is not restricted to the embodiments shown and described hereinbefore and the features of the invention which have been described with reference to the embodiments shown such as, for example, design, shape and material of the materials used, can also be present in other embodiments except when specified otherwise or prohibited per se for technical reasons.

### REFERENCE LIST

10 Film element
12, 14, 16 Light-collecting and light-conducting film coloured with daylight-fluorescent dye, in which a motif is introduced by specifically perturbing the intrinsic total relation of the film
13 Motif introduced as specific perturbations of the intrinsic total reflection of the film
17 Adhesive layer
18 Transparent metal layer
19 Scratch-protective seal
20 Substrate
32 Infrared-absorbing and/or reflecting pigments
34 Magnetic pigments
36 Contrast layer in dark colour or black
40 Steel plate
42 Gravure element
44 Side flank
46 Burr
50 Embossing
60 Pressing cylinder
62 Rubber mat
63, 64 Light-collecting and light-conducting transparent film coloured with daylight-fluorescent dye, without specifically introduced perturbation of the intrinsic total relation of the film
65, 66 Light-conducting motif layer which is connected to the transparent film (102) in a light-conducting manner and which is transparent in the visible spectrum, wherein a motif is introduced into the motif layer by specific perturbation (13) of the intrinsic total relation of the film
67 Transparent, in particular colourless intermediate layer having an optical refractive index differing from the adjoining materials
68 Light-transparent layer having optically active elements such as, for example, diffraction structures or microlenses
69 Microlenses
70 Mirror layer
71 Structured layer

1.-57. (canceled)

58. A film element for detecting authenticity, comprising:
a light-collecting and light-conducting transparent film coloured with daylight-fluorescent dye, wherein a motif which luminesces in the visible spectrum in ambient light is introduced inside the light-collecting and light-conducting transparent film by specifically perturbing an intrinsic total reflection of the light-collecting and light-conducting transparent film, and wherein the ambient light is at least one of UV light and light of the visible spectrum.

59. The film element according to claim 58, wherein the film element comprises a plurality of the light-collecting and light-conducting transparent films at least one of disposed above one another and disposed adjacent to one another.

60. The film element according to claim 58, further comprising a further film, laminated onto the light-collecting and light-conducting transparent film to form a film composite, wherein the motif contained in the light-collecting and light-conducting transparent film and a motif contained in the further film complement each other.

61. The film element according to claim 59, wherein an intermediate layer, at least partially transparent in the visible spectrum, is disposed in the film element.

62. The film element according to claim 59, wherein the plurality of light-collecting and light-conducting transparent films include films of different colours.

63. The film element according to claim 58, wherein the light-collecting and light-conducting transparent film is disposed on a substrate which is reflecting or semitransparent in the visible spectrum.

64. The film element according to claim 58, further comprising at least one layer having diffraction structures.

65. The film element according to claim 58, further comprising at least one metallised semitransparent layer.

66. The film element according to claim 58, wherein the motif is at least one of a line, dot grid, alphanumeric characters, barcodes, symbols, images, portraits, graphics and a guilloche pattern.

67. The film element according to claim 58, wherein the film element has a thickness of <100 μm.

68. A method for producing a film element for detecting authenticity, the film element including a light-collecting and light-conducting transparent film coloured with daylight-fluorescent dye, that the method comprising:
introducing a motif, which luminesces in the visible spectrum in ambient light, inside the light-collecting and light-conducting transparent film by specifically perturbing an intrinsic total reflection of the light-collecting and light-conducting transparent film by way of a laser, wherein the ambient light is at least one of UV light and light of the visible spectrum.

69. A film element for detecting authenticity, comprising:
at least one light-collecting and light-conducting transparent film coloured with daylight-fluorescent dye and at least one light-conducting motif layer which is connected to the at least one light-collecting and light-conducting transparent film in a light-conducting manner and which is transparent in the visible spectrum, wherein a motif which luminesces in the visible spectrum in ambient light is introduced inside the at least one light-conducting motif layer by specifically perturbing intrinsic total reflection of the at least one light-conducting motif layer, wherein the ambient light is at least one of UV light and light of the visible spectrum.

70. The film element according to claim 69, wherein the at least one light-collecting and light-conducting transparent film and the at least one light-conducting motif layer have an identical refractive index, at least for fluorescent light produced in the transparent film.

71. The film element according to claim 69, wherein the at least one light-conducting motif layer on the at least one light-collecting and light-conducting transparent film or adjacent to the at least one light-collecting and light-conducting transparent film, is disposed directly adjacent to this in each case.

72. The film element according to claim 69, further comprising:
a further motif layer, laminated onto the at least one light-conducting motif layer to form a layer composite, wherein a motif contained in the further motif layer and the motif contained in the at least one light-conducting motif layer complement each other.

73. The film element according to claim 69, the at least one light-collecting and light-conducting transparent film includes at least two films, each of different colours.

74. The film element according to claim 69, further comprising:
at least one layer having diffraction structures.

75. The film element according to claim 69, wherein the motif is at least one of a line, dot grid, alphanumeric characters, barcodes, symbols, images, portraits, graphics and a guilloche pattern.

76. The film element according to claim 69, wherein the film element has a thickness of <100 μm.

77. A method for producing a film element for detecting authenticity, wherein said film element comprises at least one light-collecting and light-conducting transparent film coloured with daylight-fluorescent dye and at least one light-conducting motif layer which is connected to the at least one light-collecting and light-conducting transparent film in a light-conducting manner and which is transparent in the visible spectrum, that the method comprising:
introducing a motif, which luminesces in the visible spectrum in ambient light, inside the at least one light-conducting motif layer by specifically perturbing an intrinsic total reflection of the at least one light-conducting motif layer, wherein the ambient light is at least one of UV light and light of the visible spectrum.

78. The film element of claim 58, wherein the film element is for detecting authenticity of at least one of security elements, security papers, documents of value, coins, and chips.

79. The film element according to claim 59, wherein an intermediate layer, at least partially transparent in the visible spectrum, is disposed in between two of the light-collecting and light-conducting transparent films.

80. The film element according to claim 60, wherein an intermediate layer, at least partially transparent in the visible spectrum, is disposed in between the light-collecting and light-conducting transparent film and the further film.

81. The film element according to claim 60, wherein the light-collecting and light-conducting transparent film and the further film are of different colours.

82. The film element according to claim 64, wherein the diffraction structures include at least one of diffraction lenses and refraction structures.

83. The film element according to claim 64, wherein the diffraction structures include microlenses.

84. The film element according to claim 67, wherein the film element has a thickness of <50 μm.

85. The film element according to claim 84, wherein the film element has a thickness of 5 to 30 μm.

86. The method of claim 68, wherein the method is for producing a film element for detecting authenticity of at least one of security elements, security papers, documents of value, coins, and chips.

87. The film element according to claim 74, wherein the diffraction structures include at least one of diffraction lenses and refraction structures.

88. The film element according to claim 74, wherein the diffraction structures include microlenses.

89. The film element according to claim 76, wherein the film element has a thickness of <50 μm.

90. The film element according to claim 89, wherein the film element has a thickness of 5 to 30 μm.
